(19) United States
(12) Patent Application Publication
(10) Pub. No.: US 2006/0066575 A1
(43) Pub. Date: Mar. 30, 2006

(54) Laser power control manufacturing method of matching binned laser to drive conditions through soldering and component mounting techniques to convey binning information

(76) Inventors: Michael J. Brosnan, Fremont, CA (US); Vincent C. Moyer, Milpitas, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/952,600

(22) Filed: Sep. 28, 2004

(51) Int. Cl. G09G 5/08

(52) U.S. Cl. 345/166

(57) ABSTRACT

A method for programming a function of an optical mouse during assembly includes (1) mounting a dummy resistor on a printed circuit board, the dummy resistor being indicative of a parameter of the function, (2) mounting an optical mouse sensor and a nonvolatile memory on the printed circuit board, (3) coupling a laser to the optical mouse sensor to receive a drive current, (4) further assembling the optical mouse, and (5) after the further assembling the optical mouse, determining the parameter from the dummy resistor and programming the parameter into the nonvolatile memory. During startup of the optical mouse, the optical mouse sensor is programmed with the parameter from the nonvolatile memory and drives the laser accordingly.

### DESCRIPTION OF RELATED ART

A conventional optical mouse uses a light emitting diode (LED) as the source of illumination for the optical mouse sensor. The next generation optical mouse uses a laser as the source of illumination for the optical mouse sensor. The nearly singular wavelength of laser light is capable of revealing much greater surface detail than the LED. Thus, the laser can track reliably even on tricky polished or wood-grain surfaces.

Along with the use of the laser light source come new challenges in the manufacturing of optical mice. Thus, what is needed is a method for manufacturing optical mice that accommodates the new laser light source.

### SUMMARY

In one embodiment of the invention, a method for programming a function of an optical mouse during assembly includes (1) mounting a dummy resistor on a printed circuit board, the dummy resistor being indicative of a parameter of the function, (2) mounting an optical mouse sensor and a nonvolatile memory on the printed circuit board, (3) coupling a laser to the optical mouse sensor to receive a drive current, (4) further assembling the optical mouse, and (5) after the further assembling the optical mouse, determining the parameter from the dummy resistor and programming the parameter into the nonvolatile memory. During startup of the optical mouse, the optical mouse sensor is programmed with the parameter from the nonvolatile memory and drives the laser accordingly.

In another embodiment of the invention, a method for programming a function of an optical mouse during assembly includes (1) mounting a resistor on a printed circuit board, the resistor being indicative of a parameter of the function, (2) mounting an optical mouse controller on the printed circuit board, the optical mouse controller being coupled to the resistor, (3) mounting an optical mouse sensor on the printed circuit board, (4) coupling a laser to the optical mouse sensor to receive a drive current. During startup of the optical mouse, the optical mouse controller senses the resistor and programs the parameter into the optical mouse sensor to drive the laser accordingly.

### BRIEF DESCRIPTION OF THE DRAWINGS

FIG. 1 is a flowchart of a method to record a temperature coefficient for a laser in an optical mouse in one embodiment of the invention.

FIG. 2 illustrates components of an optical mouse in one embodiment of the invention.

FIG. 3 is a flowchart of a method to record a temperature coefficient for a laser in an optical mouse in another embodiment of the invention.

FIG. 4 illustrates components of an optical mouse in another embodiment of the invention.

Use of the same reference numbers in different figures indicates similar or identical elements.

### DETAILED DESCRIPTION

In one embodiment of the invention, vertical cavity surface-emitting lasers (VCSELs) are categorized by a bin number and a bin letter (e.g., 2A, 2B, 3A, and 3B). The bin number designates the current required for a laser to obtain a given output power. The bin letter designates the temperature coefficient of the drive current needed to keep the output power of a laser constant over temperature. For cost reasons, the individual lasers may not be marked with the bin designations. Instead, the lasers are separated into containers (e.g., bags, boxes, or trays) marked with the bin designations. One of the reasons that the lasers are sorted according to their drive conditions is so that their output power can be controlled accordingly for eye-safety purposes. Note that even if the lasers are individually marked, the marking may not be visible after the laser is assembled into the optical mouse.

The laser can be used as the illumination source for an optical mouse sensor in an optical mouse. The optical mouse sensor measures changes in position by optically acquiring sequential surface images and mathematically determining the direction and magnitude of movement. The optical mouse sensor also regulates the drive current to the laser.

In one embodiment of the invention, an appropriate resistor (hereafter “bin resistor”) is coupled to the optical mouse sensor to set the correct current range for the drive current. Furthermore, a register in the optical mouse sensor is written to set (1) the correct drive current within the current range and (2) the correct temperature coefficient for the drive current. Typically during the startup of the optical mouse, an optical mouse controller reads the drive current and temperature coefficient settings from a nonvolatile memory and writes the settings into the sensor register.

During assembly, a worker receives a container full of lasers. According to the bin number on the container, the assembly worker programs the pick and place equipment to place the appropriate bin resistor onto the printed circuit board of the optical mouse. Subsequently, additional assembly of the optical mouse occurs.

After largely assembling the optical mouse, an assembly worker programs the temperature coefficient setting into a nonvolatile memory on the printed circuit board. To do this, the assembly worker needs to know the bin letter of the laser in the optical mouse. However, this point of the assembly process can be physically and temporally removed from the initial step where the laser container and the bin designations are accessible.

If one assembly worker were to mark the printed circuit board with the bin letter, then another assembly worker could read this marking and type the information into the equipment that programs the nonvolatile memory. However, this would be inefficient and error prone. Since eye-safety limits are jeopardized by mistakes, this method is not desirable.

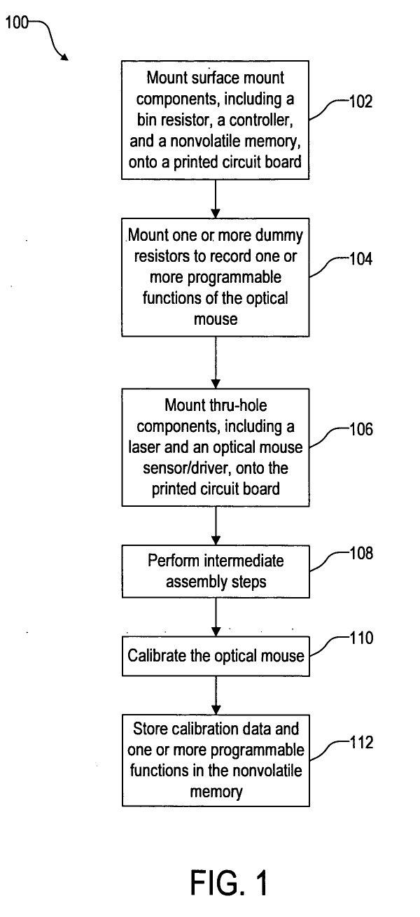

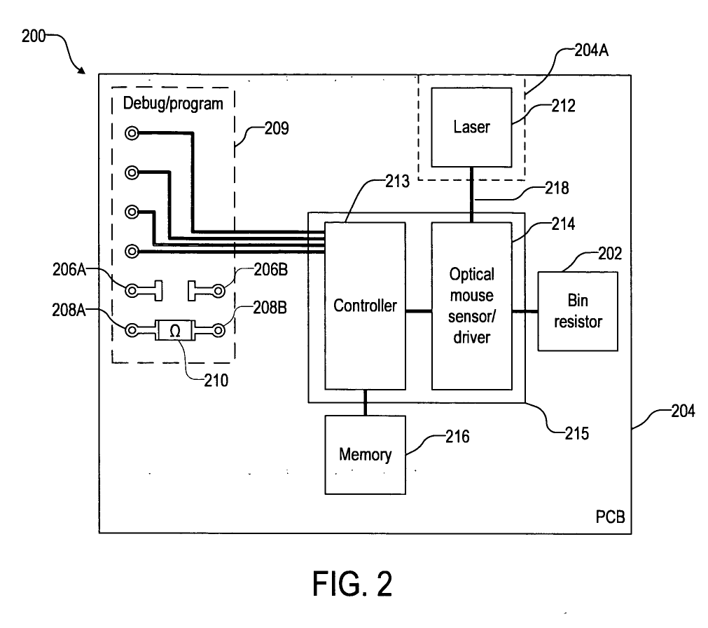

FIG. 1 illustrates a method 100 for recording the temperature coefficient of a laser in the assembly process of an optical mouse 200 (FIG. 2) in one embodiment of the invention.

In step 102, surface mount components including a bin resistor 202 (FIG. 2), an optical mouse controller 213 (FIG. 2), and a nonvolatile memory 216 (FIG. 2) are placed on a printed circuit board 204 (FIG. 2). As described above, the assembly worker can program the pick and place equipment to select and place the appropriate bin resistor 202 according to the bin number marked on the laser container.

In step 104, one or more surface mount resistors 210 (only one is shown in FIG. 2) are placed on printed circuit board 204 according to the bin letter marked on the laser container. Specifically, resistors 210 (hereafter “tempco resistors”) can be placed on solder joints between probe contacts 206A and 206B (FIG. 2), and between probe contacts 208A and 208B (FIG. 2) in debugging area 209 (FIG. 2). Tempco resistors 210 record the bin letter for later use. Tempco resistors 210 are dummy components that are not part of any circuits used during the operation of optical mouse 200. Although two pairs of probe contacts are shown, additional probe contacts may be used when necessary to record more information.

In one embodiment, tempco resistors 210 are zero-ohm resistors. For example, a single zero-ohm resistor can be used to indicate whether the temperature coefficient function of the optical mouse sensor is to be used or not. Alternatively, multiple zero-ohm resistors can be used to represent a binary code that indicates a specific temperature coefficient to be used by the optical mouse sensor. For example, with two pairs of probe contacts, one of four possible temperature coefficients can be designated.

In another embodiment, tempco resistors 210 have resistances selected to indicate the specific temperature coefficient to be used by the optical mouse sensor. Thus, there is a correspondence between specific resistance values and temperature coefficient settings.

After all the surface mount components are placed on printed circuit board 204, the assembly is passed through a reflow oven to solder these components to board 204.

In step 106, through-hole components including a laser 212 (FIG. 2) and an optical mouse sensor 214 (FIG. 2) are mounted on printed circuit board 204. Bin resistor 202 is coupled to optical mouse sensor 214 to set the drive current range of laser 212. Although shown as separate components, controller 213 and sensor 214 may be integrated into a single optical mouse control unit 215 (FIG. 2). Furthermore, laser 212 may be mounted on a tab 204A (FIG. 2) that is separated from the main printed circuit board for further assembly.

In step 108, additional steps for assembling optical mouse 200 are performed. For example, an adhesive film used to protect laser 212, controller 213, and sensor 214 from the soldering process is removed, printed circuit board 204 is joined with an optical element (e.g., a lens) and a bottom case, laser 212 on tab 204A is inserted into the optical element and held in place by a clip (at which point any bin letter marking on laser 212 becomes obscured), and laser 212 is electrically coupled to the main printed circuit board 204 (specifically sensor 214) by a flexible cable 218. Only at this point may optical mouse 200 be powered on and calibrated.

In step 110, the largely assembled optical mouse 200 is calibrated. For example, the calibration process involves measuring the optical power exiting optical mouse 200 through the optical element in a temperature controlled environment. The register of optical mouse sensor 214 is written to change the drive current setting and the calibration process is repeated until a drive current setting that achieves the desired optical power is determined. Note that the temperature coefficient of laser 212 is not be determined from the calibration process and must be known from the bin letter.

In step 112, calibration data (e.g., the drive current setting) and the temperature coefficient setting are programmed into nonvolatile memory 212. For the temperature coefficient setting, testing equipment can be used to sense the current or the resistance between the probe contacts and then automatically program the corresponding temperature coefficient setting into nonvolatile memory 212. Alternatively, an assembly worker can visually inspect the tempco resistors and then manually program the appropriate temperature coefficient setting into nonvolatile memory 212.

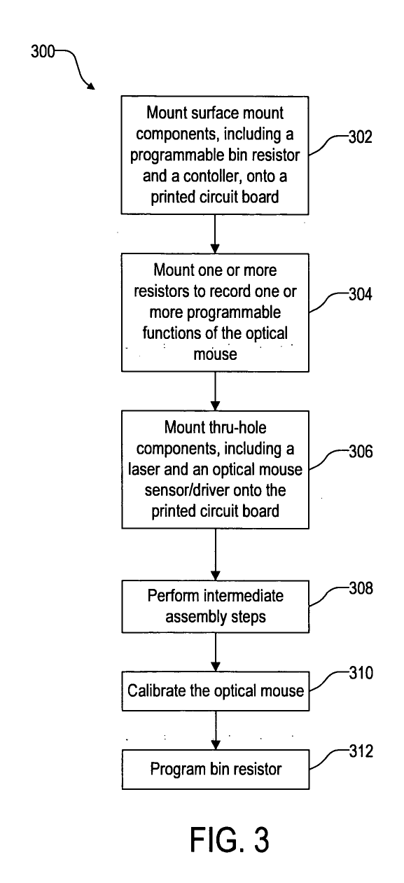

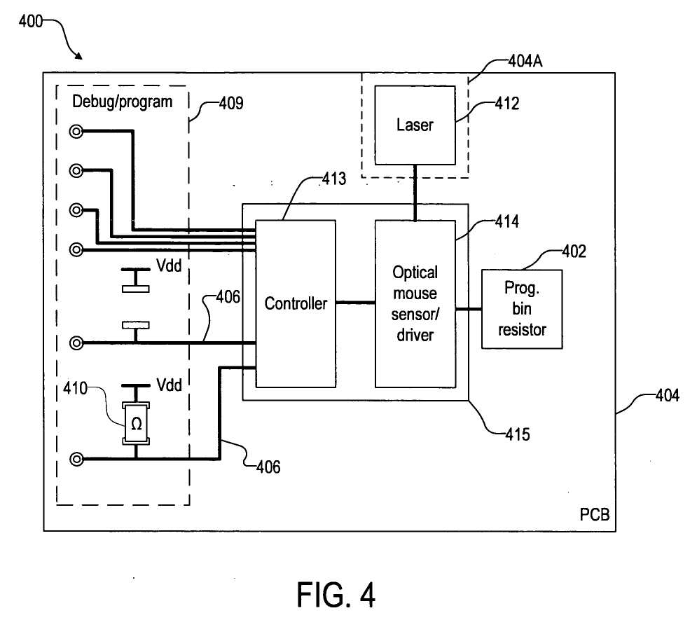

FIG. 3 illustrates a method 300 for recording the temperature coefficient of a laser in the assembly process of an optical mouse 400 (FIG. 4) in one embodiment of the invention. Unlike optical mouse 200, optical mouse 400 does not include a nonvolatile memory for recording the drive current setting. Instead, optical mouse 400 uses a bin resistor 402 (FIG. 4) with programmable resistance to set the correct drive current. For example, bin resistor 402 is a digital potentiometer. In this embodiment, an optical mouse controller 413 (FIG. 4) determines the temperature coefficient setting from the presence of tempco resistors 410 (only one is shown in FIG. 4) and programs an optical mouse sensor 414 (FIG. 4) accordingly.

In step 302, surface mount components including programmable bin resistor 402 and controller 413 are placed on a printed circuit board 404 (FIG. 4).

In step 304, one or more surface mount tempco resistors 410 are placed on printed circuit board 404 according to the bin letter marked on the laser container. Specifically, zero-ohm tempco resistors 410 can be placed on solder joints between respective traces 406 and rail Vdd (or ground) in a debugging area 409 (FIG. 4). Optical mouse controller 413 is coupled to traces 406 to sense the presence of tempco resistors 410. Whenever a tempco resistor 410 is present on a trace 406, controller 413 would sense Vdd (or ground) on that trace. Although two traces 406 are shown, additional traces may be used when necessary to record more information.

As similarly described above, a single tempco resistor 410 can be used to indicate whether the temperature coefficient function of the optical mouse sensor is to be used or not. Alternatively, multiple tempco resistors 410 can be used to represent a binary code that indicates a specific temperature coefficient to be used by the optical mouse sensor.

In step 306, through-hole components including a laser 412 (FIG. 4) and optical mouse sensor 414 are mounted on printed circuit board 404. Programmable bin resistor 402 is coupled to optical mouse sensor 410 to set the drive current of laser 412. Although shown as separate components, controller 413 and sensor 414 may be integrated into a single optical mouse control unit 415 (FIG. 4). Furthermore, laser 412 may be mounted on a tab 404A (FIG. 4) that is separated from the main printed circuit board for further assembly.

In step 308, additional steps for assembling optical mouse 400 are performed. Step 308 is similar to step 108 described above.

In step 310, the largely assembled optical mouse 400 is calibrated. Step 310 is similar to step 110 described above except that the drive current is varied by programming bin resistor 402 instead of sensor 414.

In step 312, the correct drive current setting is programmed into bin resistor 402.

The operation of optical mouse 400 is now explained. During startup, controller 413 senses the presence of tempco resistors 410 through traces 406 and then writes the corresponding temperature coefficient setting into the register of sensor 414. Sensor 414 then provides the appropriate drive current to laser 414 according to the resistance provided by bin resistor 402 and the temperature coefficient setting in the sensor register.

Various other adaptations and combinations of features of the embodiments disclosed are within the scope of the invention. Although the dummy resistors have been used to record a temperature coefficient of a laser in an optical mouse, the dummy resistors can be used to record other characteristics of other devices. Furthermore, surface mount components can be replaced with through-hole mount equivalents, and vice versa. Numerous embodiments are encompassed by the following claims.

What is claimed is:

1. A method for programming a function of an optical mouse during assembly, comprising:
mounting a dummy resistor on a printed circuit board, the dummy resistor being indicative of a parameter of the function;
mounting an optical mouse sensor and a nonvolatile memory on the printed circuit board;
electrically coupling a laser to the optical mouse sensor to receive a drive current;
further assembling the optical mouse;
after said further assembling the optical mouse:
determining the parameter from the dummy resistor;
programming the parameter into the nonvolatile memory, wherein during startup of the optical mouse, the optical mouse sensor is programmed with the parameter from the nonvolatile memory and drives the laser accordingly.

2. The method of claim 1, further comprising:
selecting a current setting resistor for regulating the drive current according to power output characteristics of the laser; and
mounting the current setting resistor on the printed circuit board, wherein the current setting resistor is electrically coupled to the optical mouse sensor to set the drive current.

3. The method of claim 1, wherein said determining the parameter is selected from the group consisting of (1) visually inspecting a presence of the dummy resistor, (2) sensing a current through the dummy resistor, and (3) sensing a resistance through the dummy resistor.

4. The method of claim 1, wherein the function comprises adjusting the drive current over temperature and the parameter enables the function.

5. The method of claim 1, wherein the function comprises adjusting the drive current over temperature and the parameter selects a temperature coefficient for the function.

6. The method of claim 1, wherein said further assembling the optical mouse comprises:
joining the printed circuit board with an optical element and a bottom case of the optical mouse;
inserting the laser into the optical element; and
electrically coupling the laser to the printed circuit board.

7. A method for programming a function of an optical mouse during assembly, comprising:
mounting a resistor on a printed circuit board, the resistor being indicative of a parameter of the function;
mounting an optical mouse controller on the printed circuit board, the optical mouse controller being electrically coupled to the resistor;
mounting an optical mouse sensor on the printed circuit board;
electrically coupling a laser to the optical mouse sensor to receive a drive current;
wherein during startup of the optical mouse, the optical mouse controller senses the resistor and programs the parameter into the optical mouse sensor to drive the laser accordingly.

8. The method of claim 7, further comprising:
mounting a programmable resistor on the printed circuit board, the programmable resistor being electrically coupled to the optical mouse sensor to set the drive current; and
programming the programmable resistor to set the drive current.

9. The method of claim 7, wherein said sensing the resistor is selected from the group consisting of (1) sensing a current and (2) sensing ground.

10. The method of claim 7, wherein the function comprises adjusting the drive current over temperature and the parameter enables the function.

11. The method of claim 7, wherein the function comprises adjusting the drive current over temperature and the parameter selects a temperature coefficient for the function.

12. An optical mouse, comprising:
a printed circuit board;
an optical mouse sensor mounted on the printed circuit board;
a laser electrically coupled to the optical mouse sensor to receive a drive current; and
a resistor mounted on the printed circuit board, wherein the resistor indicates a parameter of a function to be programmed into the optical mouse sensor for driving the laser.

13. The optical mouse of claim 12, further comprising:
a nonvolatile memory mounted on the printed circuit board, wherein the nonvolatile memory stores the parameter determined from the resistor; and
an optical mouse controller mounted on the printed circuit board, wherein during startup the optical mouse controller reads the nonvolatile memory and programs the parameter into the optical mouse sensor.

14. The optical mouse of claim 12, further comprising:
an optical mouse controller mounted on the printed circuit board, the optical mouse controller being electrically coupled to the resistor, wherein during startup the optical mouse controller senses the resistor and programs the parameter into the optical mouse sensor.

15. The optical mouse of claim 12, further comprising:
another resistor mounted on the printed circuit board, said another resistor being selected to regulate the drive current according to power output characteristics of the laser.

16. The optical mouse of claim 12, wherein the function comprises adjusting the drive current over temperature and the parameter enables the function.

17. The optical mouse of claim 12, wherein the function comprises adjusting the drive current over temperature and the parameter selects a temperature coefficient for the function.

18. A method for recording information during assembly of a device, comprising
mounting a dummy resistor on a printed circuit board, the dummy resistor indicating the information, the dummy resistor not being part of any circuit used during operation of the device.

19. The method of claim 18, further comprising:
determining the information from the dummy resistor, said determining comprises (1) sensing a current through the dummy resistor, (2) sensing a resistance through the dummy resistor, and (3) visually inspecting the dummy resistor, wherein a presence of the dummy resistor indicates the information.
